(19) United States
(12) Patent Application Publication
(10) Pub. No.: US 2013/0208029 A1
(43) Pub. Date: Aug. 15, 2013

(54) Method for Realizing Dual Operation Mode Liquid Crystal Display Device

(71) Applicants: Zexin Wu, Shenzhen (CN); Yong Zhang, Shenzhen (CN)

(72) Inventors: Zexin Wu, Shenzhen (CN); Yong Zhang, Shenzhen (CN)

(73) Assignee: Shenzhen China Star Optoelectronics Technology Co. LTD., Shenzhen City, Guangdong (CN)

(21) Appl. No.: 13/508,730

(22) PCT Filed: Mar. 23, 2012
(86) PCT No.: PCT/CN12/72864

§ 371 Date: May 8, 2012

(30) Foreign Application Priority Data
Feb. 15, 2012 (CN) 201210033973.6

(51) Int. Cl. G09G 5/10; G09G 3/36

(52) U.S. Cl. 345/691; 345/102

(57) ABSTRACT

A method for realizing a dual operation mode liquid crystal display device includes: (1) providing a liquid crystal display device, which includes a clock control chip having an enabling terminal electrically connected to an enabling signal source that has high-level and low-level output signals; (2) the enabling signal source selectively transmitting high-level and low-level output signals to the enabling terminal to cause the liquid crystal display device to selectively enter first and second operation modes, in which the display panel displays data transmitted through a data bus or image data internally loaded in the clock control chip; and (3) controlling the enabling signal source to switch between high-level and low-level output signals so as to control, via the enabling terminal, the display panel to switch between the first and second operation modes.

### BACKGROUND OF THE INVENTION

1. Field of the Invention

The present invention relates to a liquid crystal display device, and in particular to a method for realizing a dual operation mode liquid crystal display device.

2. The Related Arts

A lighting fixture is a necessary device of a bedroom. A flat light is one of the lighting fixtures and is getting popularized due to advantages of being simple in structure and consuming less power. A regular flat light is embedded in the ceiling, making it pleasing and practical.

With the progress of modern societies, a liquid crystal display device is now necessaries of each household. Besides setting up a large-sized liquid crystal display device in the living room, it is also common for many families to set up a small-sized liquid crystal display device indoors in order to watch news, operas, movies, or other amusement programs by resting on the beds. However, the liquid crystal display device is often mounted on a wall or placed on a cabinet in a bedroom and this occupies quite an amount of space inside the bedroom.

It is desired to make a liquid crystal display device also functioning as a flat light so that there is no need to separately install a flat light. This saves space and is convenient for use and also saves the money that a user has to spend for purchasing and installing a flat light. It is thus desired that the industry may develop improvement of the liquid crystal display device to provide it with dual operation modes, and at the same time easy to realize and easy to operate for the users.

### SUMMARY OF THE INVENTION

An object of the present invention is to provide a method for realizing a dual operation mode liquid crystal display device to make a liquid crystal display device showing a lighting function of flat light by integrating a liquid crystal display device and a flat light so that the amount of space occupied is reduced and the cost of operation is lowered down.

Another object of the present invention is to provide a method for realizing a dual operation mode liquid crystal display device, with which a liquid crystal display device can easily realize a lighting function of flat light and is easy to operate by a user.

To achieve the objective, the present invention provides a method for realizing a dual operation mode liquid crystal display device, which comprises the following steps:

Step 1: providing a liquid crystal display device, wherein the liquid crystal display device comprises: a display panel, a backlight module supplying light to the display panel, a clock control chip electrically connected to the display panel, a data bus electrically connected to the clock control chip, and an enabling signal source electrically connected to the clock control chip, the clock control chip being loaded therein with image data, the clock control chip comprising an enabling terminal electrically connected to the enabling signal source, the enabling signal source having a high-level output signal and a low-level output signal;

Step 2: the enabling signal source providing a signal to the enabling terminal, wherein when the enabling signal source transmits a high-level output signal to the enabling terminal, the liquid crystal display device is caused to enter a first operation mode, in which the display panel displays data transmitted through the data bus; and when the enabling signal source transmits a low-level output signal to the enabling terminal, the liquid crystal display device enters a second operation mode, in which the display panel displays the internally-loaded image data of the clock control chip; and

Step 3: controlling the enabling signal source to switch between the high-level and low-level output signals, so as to control, via the enabling terminal, the display panel to switch between the first and second operation modes.

The enabling signal source further comprises an enabling switch, whereby through triggering the enabling switch, switching of the output signal of the enabling signal source between the high-level output and the low-level output is effected.

Triggering the enabling switch is effected by a change-over switch provided on the liquid crystal display device.

Triggering the enabling switch is effected by a pushbutton of a remote controller corresponding to the liquid crystal display device.

The clock control chip further comprises a first input terminal, a second input terminal, and an output terminal. The data bus is electrically connected, via the first input terminal of the clock control chip, to the clock control chip. The display panel is electrically connected, via the output terminal of the clock control chip, to the clock control chip. The second input terminal of the clock control chip comprises an external device port so that connection with an external device is effected via the data bus for reading/writing the image data internally-loaded in the clock control chip.

The external device port is a USB port of a serial port.

The clock control chip is internally loaded with multiple types of image data, whereby when the liquid crystal display device enters the second operation mode, the display panel displays, according settings, the internally-loaded image data of the clock control chip.

The internally-loaded image data of the clock control chip are pure color images or pictures defined by a user.

The high-level output signal is a 3.3V voltage signal and the low-level output signal is a 0V voltage signal.

The first operation mode is television mode and the second operation mode is lighting mode.

The efficacy of the present invention is that the present invention provides a method for realizing dual operation mode liquid crystal display device, which uses variation of input signal level applied to an enabling terminal of a clock control chip of the liquid crystal display device to control the supply sources of data to be displayed on the display panel, so as to allow the liquid crystal display device to select between two operation modes, namely the television mode and the lighting mode, and uses switching of signal of the enabling signal source to realize switching between the two operation modes, making the use easy and convenient. The present invention provides an effective integration of a liquid crystal display device and a flat light to reduce the amount of space occupied and expenditure of use and make it easy to operate by a user. Further, the liquid crystal display device with lighting function can be embedded in a ceiling to allow a user to lie on bed to watch television programs, help releasing tiredness and improving pleasure.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, will be apparent from the following detailed description of an embodiment of the present invention, with reference to the attached drawings. In the drawings:

FIG. 1 is a flow chart showing a method for realizing a dual operation mode liquid crystal display device according to the present invention; and

FIG. 2 is a circuit block diagram for carrying out the method for realizing a dual operation mode liquid crystal display device according to the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

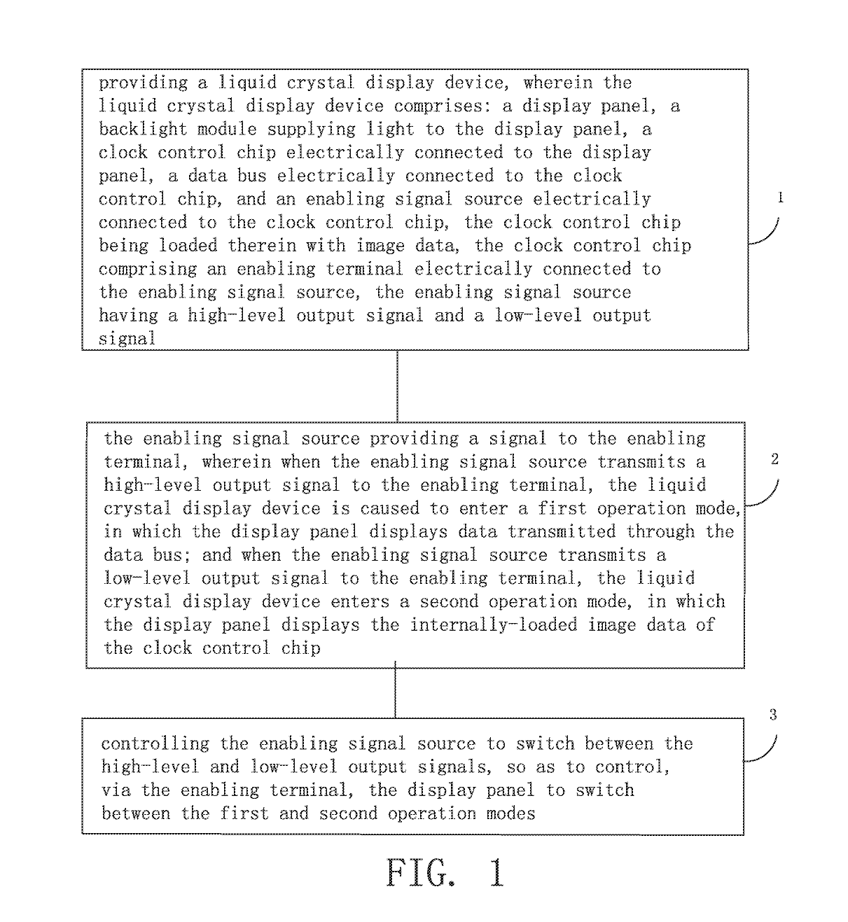

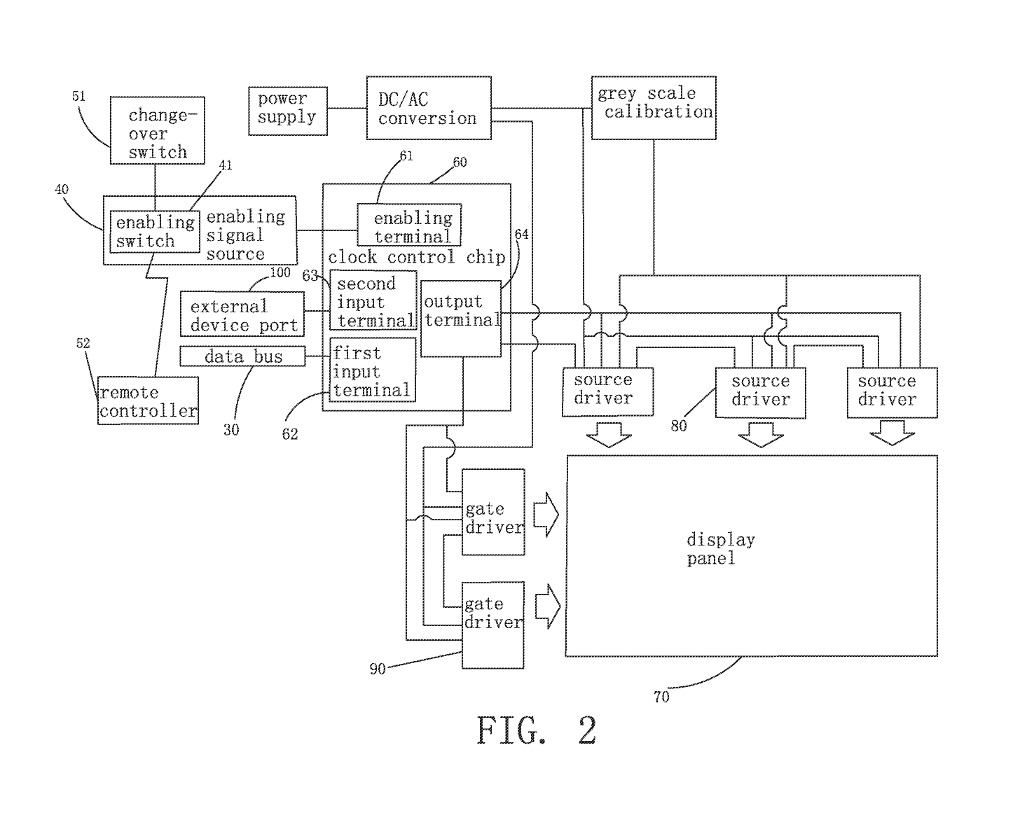

Referring to FIGS. 1 and 2, the present invention provides a method for realizing a dual operation mode liquid crystal display device, which comprises the following step:

Step 1: providing a liquid crystal display device.

The liquid crystal display device comprises: a display panel 70, a backlight module (not shown) supplying light to the display panel 70, a clock control chip 60 electrically connected to the display panel 70, a data bus 30 electrically connected to the clock control chip 60, and an enabling signal source 40 electrically connected to the clock control chip 60. The clock control chip 60 is loaded therein with image data. The clock control chip 60 comprises an enabling terminal 61 electrically connected to the enabling signal source 40. The enabling signal source 40 has a high-level output signal and a low-level output signal.

The clock control chip 60 further comprises a first input terminal 62, a second input terminal 63, and an output terminal 64. The data bus 30 is electrically connected, via the first input terminal 62, to the clock control chip 60. The display panel 70 is electrically connected, via the output terminal 64, to the clock control chip 60. The second input terminal 63 of the clock control chip 60 comprises an external device port 100, and the clock control chip 60 is set in communication with an external device (not shown) via the external device port 100 and a data line (not shown) for reading/writing the image data loaded in the clock control chip 60. The external device port 100 can be a USB (Universal Serial Bus) port or a serial port.

The enabling signal source 40 further comprises an enabling switch 41, whereby through triggering the enabling switch 41, switching of the output signal of the enabling signal source 40 between the high-level output and the low-level output can be realized. For example, triggering the enabling switch 41 once makes the output voltage of the enabling signal source 40 switched from the high-level output to the low-level output and triggering the enabling switch 41 the second time causes the output signal of the enabling signal source 40 to switch from the low-level output signal back to the high-level output signal. The triggering of the enabling switch 41 can be done with a change-over switch 51 provided on the liquid crystal display device or a pushbutton of a remote controller 52 corresponding to the liquid crystal display device. The effective time period of the enabling switch 41 is from 0 ms to 100 ms, and the specific period of time can be determined according to an actual design. Preferably, the high-level output signal is a 3.3V voltage signal and the low-level output signal is a 0V voltage signal.

Step 2: the enabling signal source 40 providing a signal to the enabling terminal 61, wherein when the enabling signal source 40 transmits a high-level output signal to the enabling terminal 61, the liquid crystal display device is caused to enter a first operation mode, in which the display panel 70 displays data transmitted through the data bus 30; and when the enabling signal source 40 transmits a low-level output signal to the enabling terminal 61, the liquid crystal display device enters a second operation mode, in which the display panel 70 displays the internally-loaded image data of the clock control chip 60. The first operation mode can be a television mode, while the second operation mode is a lighting mode. The first and second operation modes can be changed as desired.

Step 3: controlling the enabling signal source 40 to switch between the high-level and low-level output signals, so as to control, via the enabling terminal 61, the display panel 70 to switch between the first and second operation modes.

By using the change-over switch 51 of the liquid crystal display device or a pushbutton of the remote controller 52 corresponding to the liquid crystal display device to trigger the enabling switch 41, the output signal of the enabling signal source 40 is caused to switch between the high-level output signal and the low-level output signal and the input signal to the enabling terminal 61 of the clock control chip 60 is switched between the high-level output signal and the low-level output signal, whereby when the enabling terminal 61 of the clock control chip 60 is controlled by the low-level output signal, the clock control chip 60 transmits the preset internally-loaded image data of the clock control chip 60 to source drivers 80 and issues control signals to gate drivers 90 to coordinate operations of the source drivers 80 and the gate drivers 90, making the display panel 70 display the preset internally-loaded image data of the clock control chip 60, so that the liquid crystal display device enters the second operation mode, namely the lighting mode; when the enabling terminal 61 of the clock control chip 60 is controlled by the high-level output signal, the clock control chip 60 transmits the data that are transmitted through the data bus 30 to the source drivers 80 and issues control signals to the gate drivers 90 to coordinate the operations of the source drivers 80 and the gate drivers 90, making the display panel 70 display the data transmitted through the data bus 30, so that the liquid crystal display device enters the first operation mode, namely the television mode.

It is noted that the clock control chip 60 can be internally loaded with various types of image data, and the internally-loaded image data of the clock control chip 60 can be modified through an external device. For example, the image data can be pure color data of orange, yellow, green, blue, indigo, and violet or they can be data of one or more pictures. When the clock control chip 60 is set in the lighting mode and the image data are displayed by the display panel 70, the displaying can be a single image that is continuously displayed or multiple images that are alternately displayed, such as sequentially displaying pure color images of red, orange, yellow, green, blue, indigo, and violet or sequentially displaying multiple pictures that are stored by a user in the clock control chip 60 in advance thereby providing functionality of electronic album. The image displaying fashion and the image switching time can be set by using the change-over switch 51 or the remote controller 52. In the instant embodiment, the image switching time is set to one minute. Further, connection with an external device can be made through the USB port or serial port provided at the second input terminal 63 of the clock control chip 60 in order to receive external image data, whereby the liquid crystal display device, when serving as a lighting device, not only provides illumination, but also displays various images to improve pleasure.

A major difference between a liquid crystal display device and a flat light is that: the liquid crystal display device requires the liquid crystal display panel, but the flat light needs only a light-transmitting panel. The liquid crystal display panel can transmit light and does not affect the result of lighting. The above arrangement can thus be applied to integrate a liquid crystal display device and a flat light together to form a liquid crystal display device with lighting function. This provides function integration of bedroom devices, reducing the amount of space occupied and expenditure of use. The liquid crystal display device can be mounted to a wall, placed on a cabinet, or attached to a ceiling. When the liquid crystal display device is attached to the ceiling, the user may lie on bed to watch television programs, and thus improving pleasure.

In summary, the present invention provides a method for realizing dual operation mode liquid crystal display device, which uses variation of input signal level applied to an enabling terminal of a clock control chip of the liquid crystal display device to control the supply sources of data to be displayed on the display panel, so as to allow the liquid crystal display device to select between two operation modes, namely the television mode and the lighting mode, and uses switching of signal of the enabling signal source to realize switching between the two operation modes, making the use easy and convenient. The present invention provides an effective integration of a liquid crystal display device and a flat light to reduce the amount of space occupied and expenditure of use and make it easy to operate by a user. Further, the liquid crystal display device with lighting function can be embedded in a ceiling to allow a user to lie on bed to watch television programs, help releasing tiredness and improving pleasure.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A method for realizing a dual operation mode liquid crystal display device, comprising the following steps:
Step 1: providing a liquid crystal display device, wherein the liquid crystal display device comprises: a display panel, a backlight module supplying light to the display panel, a clock control chip electrically connected to the display panel, a data bus electrically connected to the clock control chip, and an enabling signal source electrically connected to the clock control chip, the clock control chip being loaded therein with image data, the clock control chip comprising an enabling terminal electrically connected to the enabling signal source, the enabling signal source having a high-level output signal and a low-level output signal;
Step 2: the enabling signal source providing a signal to the enabling terminal, wherein when the enabling signal source transmits a high-level output signal to the enabling terminal, the liquid crystal display device is caused to enter a first operation mode, in which the display panel displays data transmitted through the data bus; and when the enabling signal source transmits a low-level output signal to the enabling terminal, the liquid crystal display device enters a second operation mode, in which the display panel displays the internally-loaded image data of the clock control chip; and
Step 3: controlling the enabling signal source to switch between the high-level and low-level output signals, so as to control, via the enabling terminal, the display panel to switch between the first and second operation modes.

2. The method for realizing a dual operation mode liquid crystal display device as claimed in claim 1, wherein the enabling signal source further comprises an enabling switch, whereby through triggering the enabling switch, switching of the output signal of the enabling signal source between the high-level output and the low-level output is effected.

3. The method for realizing a dual operation mode liquid crystal display device as claimed in claim 2, wherein triggering the enabling switch is effected by a change-over switch provided on the liquid crystal display device.

4. The method for realizing a dual operation mode liquid crystal display device as claimed in claim 2, wherein triggering the enabling switch is effected by a pushbutton of a remote controller corresponding to the liquid crystal display device.

5. The method for realizing a dual operation mode liquid crystal display device as claimed in claim 1, wherein the clock control chip further comprises a first input terminal, a second input terminal, and an output terminal, the data bus being electrically connected, via the first input terminal of the clock control chip, to the clock control chip, the display panel being electrically connected, via the output terminal of the clock control chip, to the clock control chip, the second input terminal of the clock control chip comprising an external device port so that connection with an external device is effected via the data bus for reading/writing the image data internally-loaded in the clock control chip.

6. The method for realizing a dual operation mode liquid crystal display device as claimed in claim 5, wherein the external device port is a USB port of a serial port.

7. The method for realizing a dual operation mode liquid crystal display device as claimed in claim 1, wherein the clock control chip is internally loaded with multiple types of image data, whereby when the liquid crystal display device enters the second operation mode, the display panel displays, according settings, the internally-loaded image data of the clock control chip.

8. The method for realizing a dual operation mode liquid crystal display device as claimed in claim 1, wherein the internally-loaded image data of the clock control chip are pure color images or pictures defined by a user.

9. The method for realizing a dual operation mode liquid crystal display device as claimed in claim 1, wherein the high-level output signal is a 3.3V voltage signal and the low-level output signal is a 0V voltage signal.

10. The method for realizing a dual operation mode liquid crystal display device as claimed in claim 1, wherein the first operation mode is television mode and the second operation mode is lighting mode.
